(19) United States
(12) Patent Application Publication
(10) Pub. No.: US 2026/0238154 A1
(43) Pub. Date: Aug. 13, 2026

(54) Method for Determining the Motor Temperature And/or Ambient Temperature for a Rotating Machine

(71) Applicant: KSB SE & Co. KGaA, Frankenthal (DE)

(72) Inventor: Klaus KRECKLER, Frankenthal (DE)

(21) Appl. No.: 19/158,925

(22) PCT Filed: Feb. 22, 2024
(86) PCT No.: PCT/EP2024/054530

§ 371 Date: Aug. 22, 2025

(30) Foreign Application Priority Data
Feb. 24, 2023 (DE) 10 2023 104 588.1

(51) Int. Cl. H02P 29/68; G01K 7/42; H02P 29/40

(52) U.S. Cl. CPC H02P 29/68; H02P 29/40; G01K 7/42

(57) ABSTRACT

A method for determining the motor temperature and/or ambient temperature for a rotating machine, the method includes controlling a power consumption of an electric motor with at least one electronic power module, which controls the power consumption of the motor by open-loop/closed-loop control. The method also includes providing a means for sensing the operating temperature of the power module and for sensing the motor current. The method also includes providing, for the power module and the motor, a cooling means that, during operation, generates a cooling effect for the motor and a cooling effect for the power module that are interdependent in a defined manner. The motor temperature and/or the ambient temperature are/is estimated on the basis of the sensed operating temperature of the power module and the sensed motor current.

### CROSS REFERENCE TO RELATED APPLICATION

This application is a 371 National Stage Application of PCT/EP 2024/054530, filed Feb. 22, 2024, which claims priority from German Patent Application No. 102023104588.1, filed Feb. 24, 2023, the entire disclosure of which is herein expressly incorporated by reference.

### BACKGROUND

The disclosure relates to a method for determining the motor temperature and/or ambient temperature for a rotating machine, comprising an electric motor for driving a rotating component part of the machine, and at least one power module for controlling the current consumption of the motor by open-loop/closed-loop control, wherein means are provided for sensing the operating temperature of the power module and for sensing the motor current, and there is provided, for the power module and the motor, a cooling means that, during operation, generates a cooling effect for the motor and a cooling effect for the power module that are interdependent in a defined manner.

Monitoring the ambient temperature and the motor temperature of a rotating machine during operation is important in order, inter alia, to recognize thermal overload situations of the motor in good time, as otherwise there is a risk of thermal destruction of the machine. Sensors for directly measuring the operating temperature of the motor and/or for measuring the ambient temperature on the machine are usually installed for the purpose of monitoring. However, the provision of separate sensors for temperature sensing not only increases the production and maintenance costs of the machine, but may also result in an increase in susceptibility to faults, as reliable monitoring is no longer possible if the sensor system fails.

A non-sensor approach to thermal monitoring of the drive system is already known in the pump sector. Here, a dynamic upper limit, i.e. an upper limit dependent on an operating point, for the motor current is defined for the motor, or the electronics, and monitored for compliance. If the prevailing current consumption of the motor exceeds this upper limit, the machine is switched off, or at least the motor power is reduced. The upper limit in this case is defined for a worst-case scenario for safety reasons, for example for the highest conceivable ambient temperature. This, however, results in a premature thermal switch-off, or power reduction, occurring at lower ambient temperatures, and the full permissible operating range of the motor not being utilizable.

Moreover, with the above method, the ambient temperature cannot be sensed, and possible operation outside of the permissible temperature range for the ambient temperature may not even be recognized.

### SUMMARY

Proceeding from the above considerations, it is therefore the object of the present disclosure to find a way of monitoring, or determining, the motor temperature, or the ambient temperature, without use of a separate sensor system, that is capable of overcoming the aforementioned disadvantages.

This object is achieved by a method according to the features of claim 1. Advantageous embodiments of the method are the subject-matter of the dependent claims.

According to the disclosure, it is proposed to estimate the motor temperature and/or the ambient temperature of the machine on the basis of the sensed operating temperature of the electronic power module and the sensed motor current. The motor current is understood to be the motor current present at the output of the power module and supplied to the motor. Measurement of the motor current measurement is preferably effected in or on the power module.

The approach according to the disclosure is based on the premise that the motor current controlled, or adjusted, by the power module corresponds to the motor current consumed by the electric motor, and thus provides information regarding the prevailing motor power. On the assumption that both the motor and the power module assume at least one temperature in accordance with the ambient temperature, the temperature value of the prevailing operating temperature of the power module, or the motor, that exceeds the ambient temperature (also referred to as heating or overtemperature of the power module or the motor) is largely caused by the losses that occur during operation, with the associated build-up of heat. The greatest proportion, at least when the machine is in proper condition, is caused by the electrical power loss, the level of which is largely dependent on the prevailing motor current.

A further factor influencing the operating temperature of the motor and power module is any active cooling of the two components. Provided that there is a defined interdependence between the cooling effects generated, for the power module on the one hand and for the motor on the other hand, or that they correlate with each other, a deduction may be made regarding the present ambient temperature and the motor operating temperature on the basis of the sensed operating temperature of the power module and the sensed motor current. Based on this knowledge, it is now possible to estimate sufficiently accurate temperature values for the ambient temperature and/or motor operating temperature.

One advantage of the method is that it is not dependent on the ambient temperature and the current operating point of the rotating machine. This allows stable and reliable temperature estimation over the entire permissible operating range of the machine and avoids the disadvantages of the prior art. Overall, the machine, and in particular the electric drive, can be operated and safely monitored with the full thermal operating range being utilized.

Preferably, the method provides for determining the power-module heating (power-module overtemperature), generated in the power module, on the basis of the sensed motor current. As already explained above, the heat loss generated internally in the power module is largely caused by the electrical power loss, such that the measured motor current is a suitable indicator of the heat loss generated in the power module, and therefore of the heating of the power module compared to the ambient temperature. This relationship can be defined mathematically, in particular on the basis of a previously defined correlation equation. As the actual correlation depends on the specific design of the machine and the choice of material, this must be determined in advance for each machine type, or ideally for each individual machine, using a training procedure. The term machine here includes not only the drive motor, but also the entire system of the rotating machine, i.e. for example also a hydraulic pump unit to be driven by the motor.

Once the power-module heating has been ascertained on the basis of the motor current, the ambient temperature can be calculated in the next step. For this purpose, it is assumed that the operating temperature of the power module corresponds to the sum of the ambient temperature and the generated power-module heating. Since the operating temperature of the power module is also measured, the ambient temperature may be calculated by subtracting the estimated power-module heating.

According to a further preferred procedure, the motor heating generated in the motor is likewise ascertained on the basis of the sensed motor current. Since the motor current generated by the power module corresponds to the motor current consumed by the stator, here likewise the waste heat in the motor, generated by electrical losses, and thus the temperature increase compared to the ambient temperature, can also be determined. Here likewise, the mathematical relationship between motor current and generated heating is determined in advance for the individual machine type or the individual machine, and stored as a correlation equation in the control system.

For the calculation of the motor operating temperature, it is preferably assumed that this corresponds to the sum of the ambient temperature and the motor heating. As already explained above, both variables can be determined from the measurement values motor current and operating temperature of the power module. Clearly, it does not matter whether the ambient temperature has actually been determined beforehand or whether the mathematical relationship between the sensed motor current and the operating temperature of the power module is used instead.

In the simplest case, the correlation equations on which the method is based correspond to a linear, time-invariant system, i.e. the power-module heating and/or the motor heating each develop in proportion to the consumed motor current. The linear relationship must be determined individually for different machine types, ideally for each individual machine.

However, experience has shown that the assumption of time invariance does not adequately reflect reality, and instead represents a simplification. In practice, however, the operating temperature, or heating, of the power module and/or of the motor will not change synchronously with the motor current, but rather there will be a time delay due to the specific heat capacity of the materials used. Since the simplification described above may result in the machine being unwantedly and prematurely switched off, or in some other control intervention, in particular in the event of only a brief increase or fluctuation in current, it is preferred instead to also take the thermal inertia of the component parts into consideration accordingly. It is therefore proposed preferably to supplement the corresponding correlation equations with a suitable timing element so as to enable the thermal inertia of the power module and of the motor to be mapped appropriately.

As a rule, the thermal inertia of the power module and motor will differ considerably. Against this background, it is therefore proposed that the time delay for calculating the motor operating temperature, or motor heating, be significantly greater than any time delay in calculating the ambient temperature, or power-module heating. Due to the structural size of the power module, the thermal inertia of the power module may also theoretically be disregarded. The time elements used are also determined individually in advance using a training procedure, depending on the machine or machine type.

The training procedure referred to is preferably performed with the use of at least one sensor for measuring the ambient temperature, and one sensor for measuring the absolute motor operating temperature, to enable corresponding correlation equations and delay values to be determined on the basis of the measured values. Ideally, the training procedure is executed at a high ambient temperature. A high ambient temperature is, for example, a temperature in the upper limit range of the maximum permissible temperature operating range of the machine. Ideally, the training procedure is selected at an ambient temperature corresponding to the upper temperature limit of the permissible operating range of the machine.

As already explained above, it is an essential prerequisite for the execution of the method that there is a defined interdependence between an active cooling of the power module and that of the motor. It may therefore be assumed that the influence of the active cooling upon the operating temperature of the power module and of the motor is the same, or at least predictable, depending on the operating point. In terms of design, this condition is fulfilled, for example, if the active cooling of the power module and of the motor is provided by a common cooling system. For example, in the case of air cooling, a cooling flow is generated by a common fan, with the cooling air flows ideally running in parallel. The common fan may be an externally driven fan. Ideally, however, the fan impeller is driven by the motor itself, the fan impeller being seated, in particular, on the motor shaft. This means that the cooling capacity is dependent on the rotational speed of the motor.

The power module used is, for example, a semiconductor element for open-loop, or closed-loop, current control, such as, for example, a semiconductor switch of an inverter, or the power module corresponds to the inverter module. The power module may be a transistor module, in particular an IGBT module. Ideally, such a module already includes an integral temperature measurement, or integral measurement of the output current to be controlled, such that the corresponding measurement values may be tapped at signal outputs of the module package.

Execution of the method is advantageous, in particular, for such machines that are characterized by a quadratic variation of the motor torque in relation to the motor rotational speed, or by a cubic variation of the electric power in relation to the motor rotational speed.

For monitoring the motor temperature, it may be provided that the estimated motor temperature is compared against a limit value and, if this is exceeded, the motor power is reduced until the machine stops completely.

The rotating machine may be a pump, in particular a centrifugal pump. Since pumps, especially, are characterized by a quadratic variation of the torque in relation to the rotational speed, i.e. a cubic variation of the electrical power consumption in relation to the rotational speed, the application of the method provides good estimation results, especially in the case of pumps. In addition, pumps often use a common cooling system for the power electronics and the motor, this additionally depending on the rotational speed of the motor, which means that the estimation accuracy is very high.

Finally, the disclosure also relates to a rotating machine, in particular a pump, particularly preferably a centrifugal pump, having an electric motor for driving a rotating component part of the machine, in particular a pump impeller, and at least one power module for controlling the current consumption of the motor by open-loop/closed-loop control. The machine also comprises means, in particular a sensor system for sensing the operating temperature of the power module and for directly or indirectly measuring the motor current. The machine is additionally equipped with a cooling system for cooling the power module and the motor. The cooling outputs, actively generated during machine operation, for the power module and the motor are interdependent. According to the disclosure, the machine comprises a control system configured to perform the method according to the disclosure. This results in the same advantages and features for the machine as already explained above with reference to the method according to the disclosure. For this reason, the description will not be repeated.

Further advantages and features of the disclosure will be explained in more detail below with reference to an exemplary embodiment represented in the figures, in which:

### BRIEF DESCRIPTION OF THE DRAWINGS

FIG. 1: shows a sectional representation of a pump according to the disclosure,

FIG. 2: shows a flow diagram of the method according to the disclosure with the use of time-invariant correlation equations,

FIG. 3: shows the exemplary embodiment shown in FIG. 2 with modification for consideration of thermal inertia,

FIG. 4: shows a diagrammatic representation to illustrate the correlation between motor current and heating of the power module,

FIG. 5: shows a diagrammatic representation to illustrate the correlation between motor heating and power-module heating,

FIG. 6: shows a diagrammatic representation to illustrate the power consumption of a pump in dependence on the rotational speed, and

FIG. 7: shows a diagrammatic representation to illustrate the correlation between the motor current and the loss-related motor heating.

### DETAILED DESCRIPTION

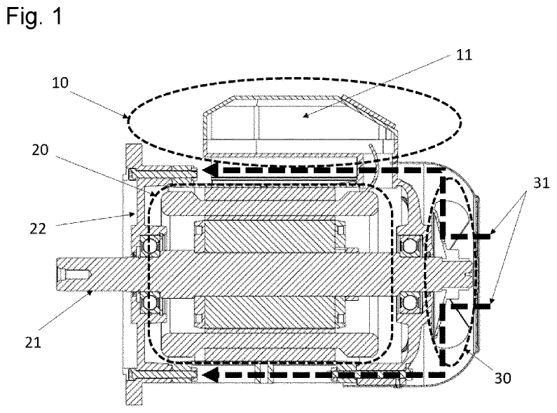

The disclosure will be described in more detail below using, as an example, a rotating machine in the form of a centrifugal pump. FIG. 1 shows a longitudinal section through the pump drive of a centrifugal pump. For simplification, the hydraulic part of the pump is not represented. The figure shows the electric motor 20 with the driven motor shaft 21. Located on the periphery of the motor housing 22 there is an electronics housing 10, which inter alia comprises the power electronics 11 of the frequency converter for controlling the electric motor 20 by open-loop/closed-loop control. The power electronics 11 comprises at least one transistor module (for example an IGBT module) for realizing an inverter of the frequency converter. The transistor module corresponds to the sophisticated electronic power module.

Both the motor 20 and the power electronics 11 inside the electronics housing 10 are cooled by air cooling. To generate the air flow, mounted on the shaft 21 there is a fan impeller 30 that generates a cooling air flow 31 flowing around the periphery of the motor housing 22. This not only cools the motor housing 22, and thus the motor 20, but also flows past the heat-conducting underside of the electronics housing 10, ensuring sufficient heat removal of the heat loss generated by the power electronics 11, in particular by the transistor module, in the electronics housing 10.

To avoid thermal overloading of the motor 20, the operating temperature of the motor 20 is monitored continuously while the pump is operating. In addition, continuous monitoring of the ambient temperature is effected in order to avoid pump operation under non-permissible external conditions.

To monitor the operating temperature of the motor 20 and the ambient temperature, however, no separate sensor system is used to measure these variables; instead, the method according to the disclosure is implemented within the pump controller, which estimates the motor operating temperature and the ambient temperature with the use of correlations based on the operating temperature of the power module, hereinafter referred to as the transistor temperature, and the set motor current, hereinafter referred to as the transistor current, of the installed IGBT module in the electronics housing 10. The result of the estimate is not dependent on the operating point and external influences (ambient temperature, load, various disturbance variables).

Commercially available transistor modules (IGBT modules or similar) have an integral temperature sensor that measures the temperature in the transistor and protects it from overheating. Such modules are also already equipped with an integrated current measuring system. In the case of commercially available transistor modules, therefore, the measurement values are already available at assigned signal outputs of the modules.

In general, the following relationship applies to the estimation using the method, also referred to as the thermal correlation method:
The transistor temperature is obtained from the sum of the ambient temperature and the transistor overtemperature. In the following, the heating caused by losses in the power module, or transistor module, compared to the ambient temperature is referred to as transistor overtemperature.
The motor temperature is obtained from the sum of the ambient temperature and the motor overtemperature. In the following, motor overtemperature is understood to be the temperature rise in the motor, caused by losses, compared to the ambient temperature.
Due to the direct electrical connection between the power electronics and the motor, the motor current consumed by the stator corresponds to the transistor current.
The transistor current causes the greatest losses in the transistor, and therefore the greatest increase in the transistor overtemperature. The same applies to the motor current and the motor overtemperature.

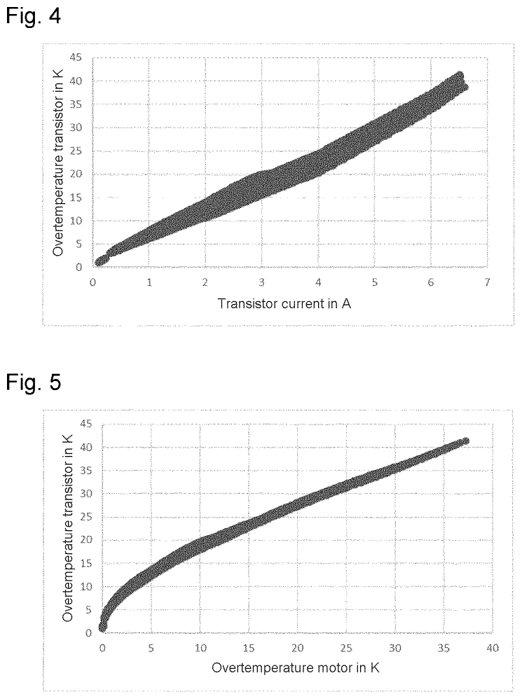

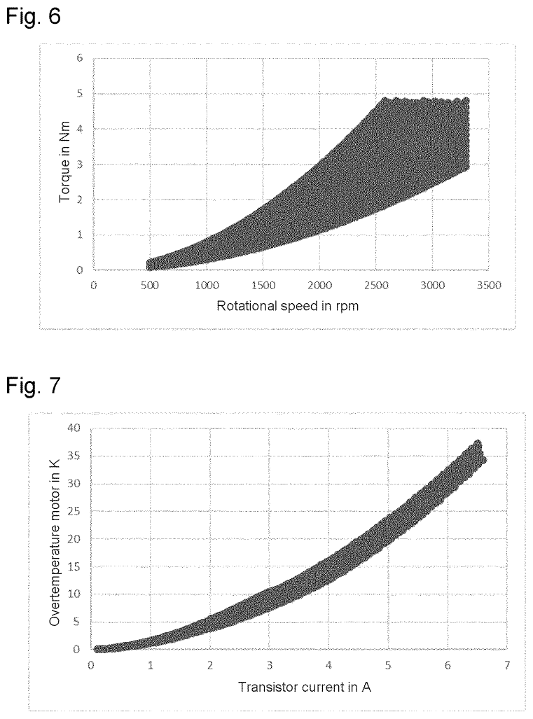

On this basis, the disclosure utilizes the following correlations, which apply to the entire operating range of the pump:
Correlation A): The transistor overtemperature is directly dependent on the transistor current, and both correlate over the entire operating range. This is illustrated in FIG. 4, according to which the transistor overtemperature shows an approximately linear (proportional) increase with increasing transistor current.
Correlation B): Due to the common cooling system and the transistor current, or motor current, as the common main source of loss, the overtemperatures of the motor and transistor correlate (see FIG. 5). Here, too, an approximately linear relationship can be identified.
The two correlations A and B mentioned above apply to the entire operating range of the pump, as can be seen from FIG. 6, which shows an example of the torque variation over the rotational speed achieved by the motor. In particular, the diagrammatic representation shows the characteristics for pump applications, in which the power consumption usually increases quadratically with the rotational speed.

The following values can be derived from the aforementioned correlations A) and B):
Based on both correlations A), B), the motor overtemperature can be described in dependence on the transistor current. The motor temperature can therefore be estimated on the basis of the transistor current and the transistor temperature.
Additionally, the ambient temperature can be estimated on the basis of correlation A.

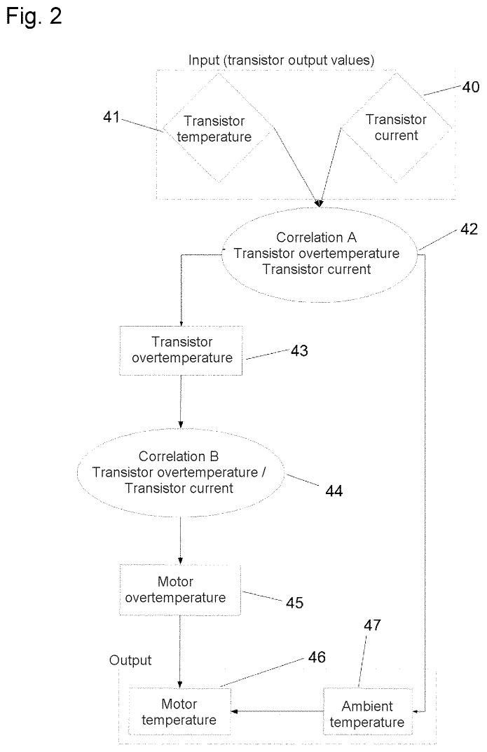

The basic method sequence is represented in FIG. 2. During operation, the prevailing transistor temperature and the prevailing transistor current are tapped at the signal output of the IGBT module (blocks 40, 41). On the basis of these two direct measurement values, and by means of the aforementioned correlation equation A, it is then possible to estimate the transistor overtemperature (block 42), which is then held ready for the further execution of the method to calculate the motor operating temperature (block 43). Then, using the correlation equation B, the transistor overtemperature and the measured transistor current, the motor overtemperature (block 44) can be estimated, and the motor temperature calculated on that basis. The motor temperature is then output, or used further for monitoring, for example against a permissible limit value (block 46).

At the same time, the ambient temperature can be calculated by subtracting the transistor overtemperature from the measured transistor temperature (block 42), and supplied to a downstream output or monitoring process (block 47).

The method according to the disclosure thus estimates the motor temperature independently of the ambient temperature. The motor 20, and optionally also the power electronics, may thus be fully utilized over the entire operating range. Ambient temperatures above the permissible temperature range are recognized, and the drive system can be protected. Additionally, the method is not dependent on the losses in the bearing and in the impeller. Deviations in the bearing friction result, for example, in a change in the transistor current, which in turn leads to a change in the motor temperature. However, the method described above always assumes a thermally steady state. In practice, however, the motor 20 and power electronics 11 must run at a defined operating point for a relatively long period of time before the two components 11 and 20 actually assume the correlated temperatures. This is due to the thermal inertia of the materials used, the inertia of the motor 20 being of course significantly greater than the thermal inertia of the transistor module.

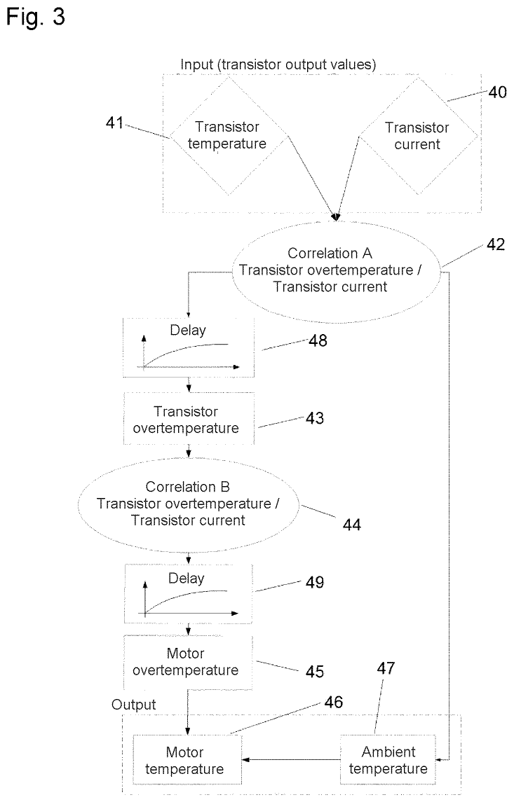

If the thermal inertia is not taken into account, the estimated temperature value may be too high, in particular if the current consumption increases only briefly. In this case, the permissible operating range of the machine may not be fully utilizable if there is a premature switch-off or a reduction in power. However, utilization can be further optimized if the estimated motor temperature is compensated over time. This modification is shown in FIG. 3. The flow diagram corresponds to the version shown in FIG. 2, but here, in the estimating of the transistor overtemperature by means of correlation equation A, an additional time element 48 is introduced, which reflects the delayed increase in the transistor overtemperature relative to the increasing transistor current. Similarly, such a time element 49 is inserted in calculation of the motor overtemperature based on correlation equation B in order to compensate for the thermal inertia of the motor. In this case, the timing element 49 is characterized by a significantly greater delay compared to the timing element 48.

The determination of the correlation equations A, B and of the time elements must be established in advance by measurement, with an external sensor system, for sensing the absolute motor operating temperature and the ambient temperature, being used for such a training procedure, preferably at high ambient temperature. The further, optionally required variables are already present in the closed-loop control of the drive (motor current and motor speed), and may be determined by measurement (thermal time constants motor and power electronics).

The temperature estimation performed by means of the method also offers sufficient protection against possible overheating of the motor in the event of a partial defect in the cooling system. If the function of the cooling system is impaired, for example due to fouling, or a partial defect in the fan, this manifests itself in a reduced cooling capacity for the IGBT and the motor, causing a physical increase in the temperature in the motor and the IGBT. In the first step, the method determines, on the basis of the correlation between the IGBT temperature and the IGBT current, the ambient temperature, which is overestimated due to the higher measurement value for the temperature in the IGBT. Based on this, a motor temperature is then estimated (correlation B), at least for highly efficient motors, that is higher than the actual physical motor temperature. The thermal correlation method is therefore safe, as in the event of a fault it estimates an excessively high motor temperature.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1-15. (canceled)

16. A method for determining the motor temperature and/or ambient temperature for a rotating machine, comprising:
controlling a power consumption of an electric motor with at least one electronic power module, which controls the power consumption of the motor by open-loop/closed-loop control;
providing a means for sensing the operating temperature of the power module and for sensing the motor current;
providing, for the power module and the motor, a cooling means that, during operation, generates a cooling effect for the motor and a cooling effect for the power module that are interdependent in a defined manner, wherein
the motor temperature and/or the ambient temperature are/is estimated on the basis of the sensed operating temperature of the power module and the sensed motor current.

17. The method as claimed in claim 16, wherein the power-module heating caused by electrical losses in the power module is determined on the basis of the sensed motor current, in particular on the basis of a correlation equation established in advance.

18. The method as claimed in claim 17, wherein the ambient temperature is determined on the basis of the operating temperature of the power module minus the power-module heating established for the power module.

19. The method as claimed in any claim 18, wherein the motor heating caused in the motor by electrical losses of the motor is established on the basis of the sensed motor current using a correlation equation determined in advance.

20. The method as claimed in claim 19, wherein the motor temperature is established by summing the motor heating and the ambient temperature previously determined on the basis of the sensed motor current and the operating temperature of the power module.

21. The method as claimed in claim 20, wherein a linear correlation equation is used for the determination of the power-module heating and/or for the determination of the motor heating.

22. The method as claimed claim 21, wherein a time delay is taken into consideration for the determination of the power module heating and/or for the determination of the motor heating, in order to take into consideration the specific heat capacity of the power module and of the motor.

23. The method as claimed in claim 22, wherein the time delay for the determination of the motor heating is selected so as to be greater than the time delay for the determination of the power-module heating.

24. The method as claimed in claim 23, wherein the correlation equations and/or the time delay values are determined in advance during a training procedure, including a sensor for measuring the ambient temperature and/or the motor temperature, wherein the training procedure is preferably executed at a high ambient temperature.

25. The method as claimed in claim 24, wherein the cooling for the power module and the motor is provided by a common cooling system including an externally driven fan, or by a fan driven by the motor.

26. The method as claimed in claim 25, wherein the power module is a transistor module that comprises integral temperature measurement and/or integral current measurement.

27. The method as claimed in claim 26, wherein the cooling effect generated for the power module and the motor is dependent on the motor rotational speed, which increases in a defined manner with increasing rotational speed.

28. The method as claimed in claim 27, wherein the determined motor temperature is compared against a limit value and, if this is exceeded, a power reduction of the motor is executed.

29. The method as claimed in claim 28, wherein the rotating machine is a centrifugal pump.

30. A centrifugal pump, comprising:
an electric motor configured to drive a rotating component part of the machine;
at least one power module configured to control the current consumption of the motor by open-loop/closed-loop control;
means for sensing the operating temperature of the power module and for sensing the motor current; and
a cooling system configured to cool the power module and the motor, wherein the cooling system outputs, a cooling effect generated during operation, for the power module and for the motor and being interdependent in a defined manner, wherein the machine comprises a control system configured to perform the method according to claim 29.
